(19) United States
(12) Patent Application Publication
(10) Pub. No.: US 2021/0400881 A1
(43) Pub. Date: Dec. 30, 2021

(54) STAND FOR HAY BALES AND METHOD

(71) Applicant: Western Pro Feeders, LLC, Oklahoma City, OK (US)

(72) Inventors: Glen Leslie McAlister, Savery, WY (US); Robert Brent Hammons, Edmond, OK (US)

(73) Assignee: Western Pro Feeders, LLC, Oklahoma City, OK (US)

(21) Appl. No.: 17/362,920

(22) Filed: Jun. 29, 2021

Related U.S. Application Data
(60) Provisional application No. 63/045,545, filed on Jun. 29, 2020.

(51) Int. Cl. A01F 25/00

(52) U.S. Cl. CPC A01F 25/00; B29C 39/003

(57) ABSTRACT

This invention relates to a stand for supporting hay bales above the ground. The inventive hay stand The device is formed in the shape of an rectangular prism or cuboid from an inert plastic, closed-cell, polyurethane structural foam that will not allow water or air to move through it. The devices are constructed by pouring the structural foam material into forms that are constructed to yield the desired shape. The structural foam has two chemicals that are mixed and then poured into the form. The foam then heats and rises to take on the shape of the interior of the form. Once the foam is fully cured, the forms are removed, and the device is ready for use. Hay stands constructed in accordance with the present invention are useful for protecting hay bales from spoilage due to ground moisture.

### CROSS REFERENCE TO RELATED APPLICATIONS

This application claims the benefit of U.S. provisional application No. 63/045,545 entitled “Hay Saver,” filed Jun. 29, 2020, the contents of which are incorporated herein by reference.

### FIELD OF THE INVENTION

The present invention relates to the field of stands for supporting hay bales above the ground.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate preferred embodiments of the invention and are not to be construed as limiting the scope of the invention.

FIG. 1 is a perspective view of a preferred embodiment of the present invention.

FIG. 2 is a side view of a form used to make a preferred embodiment of the present invention.

FIG. 3 is a perspective view of a preferred embodiment of the present invention supporting a bale of hay.

FIG. 4 is a side view of a preferred embodiment of the present invention.

FIG. 5 shows plan and side views of an alternative embodiment of the present invention.

FIG. 6 is a perspective view of an alternative embodiment of the present invention.

FIG. 7 is a perspective view of an alternative embodiment of the present invention supporting a hay bale.

FIG. 8 is a side view of an alternative embodiment of the present invention supporting a hay bale.

FIG. 9 is a perspective view of an alternative embodiment of the present invention.

FIG. 10 is a perspective view of an alternative embodiment of the present invention.

### DETAILED DESCRIPTION OF THE PREFERRED EMBODIMENT(S)

The present invention provides a stand for hay bales. Hay bales stored on the ground outdoors can take on moisture, leading to early deterioration and as much as 50% spoilage of the hay. Devices constructed in accordance with the present invention are useful for protecting hay bales from spoilage due to ground moisture. The device is economically advantageous and is useful for both round and square bales of hay and other animal feedstock provided in bales (collectively “hay”).

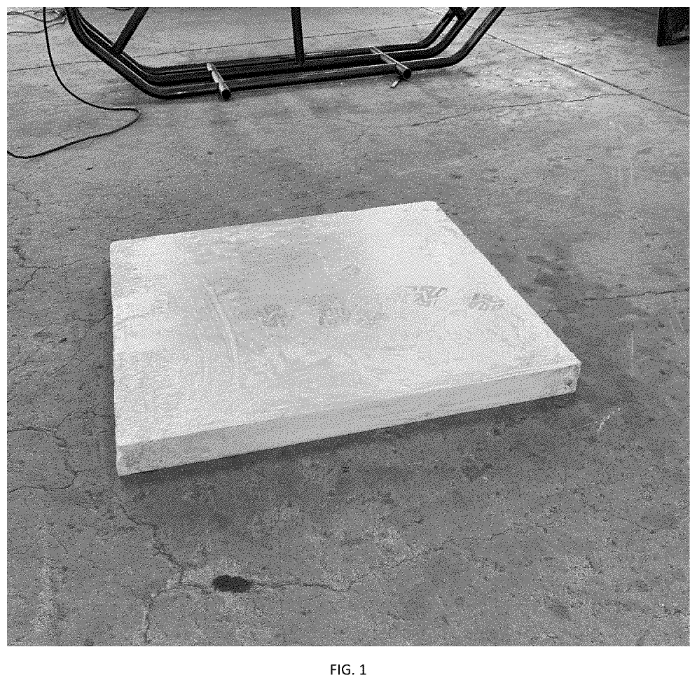

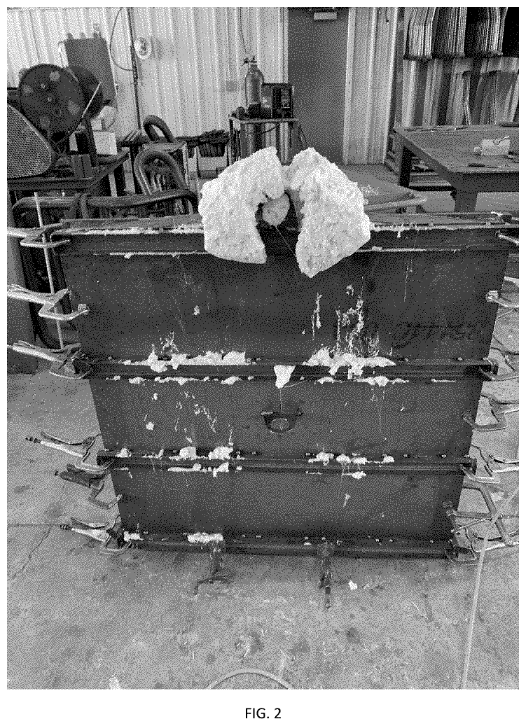

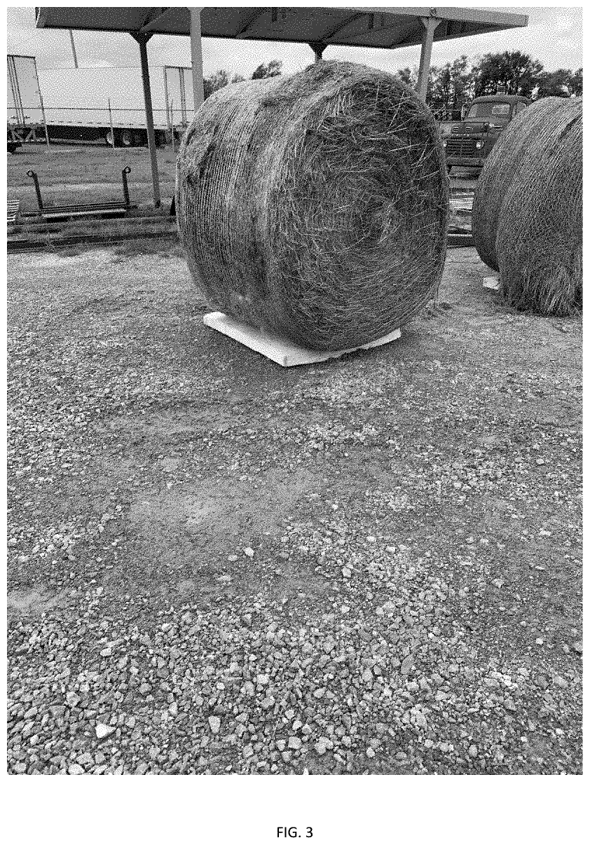

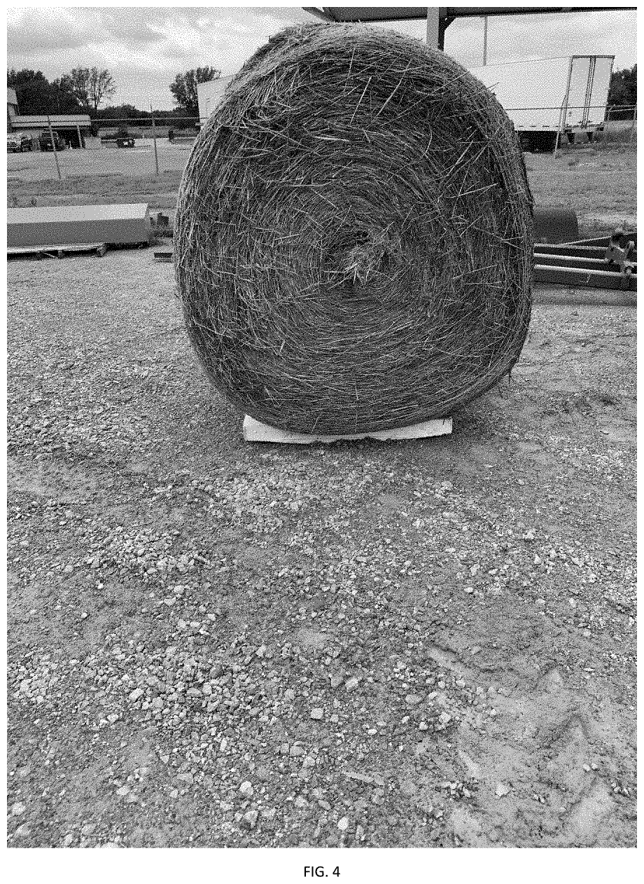

FIGS. 1-4 show one embodiment of a hay stand 10 constructed in accordance with the present invention. The hay stand 10 has a solid body 12 that is preferably formed in the shape of a rectangular prism or cuboid. Persons skilled in the art will recognize other shapes suitable for the present invention. The solid body 12 of the hay stand 10 is formed from an inert plastic, closed-cell, polyurethane structural foam that will not allow water or air to move through it. A particularly well-suited structural foam product is sold by GRA Services International of Oklahoma City, Okla. under the Secure Set trademark. Such material does not leach and has no nutritional value that would promote fungicidal or bacterial growth. It also has no effect on the soil or hay. The hay stand 10 is lightweight and can be stacked for storage or transportation. In some embodiments, the hay stand 10 is constructed with a reinforced hole (not shown) that can be used with a stacking rack having a base and a vertical dowel or rod (not shown). The hay stands 10 are stacked onto the stacking rack by threading the reinforced hole onto the vertical rod. This allows for convenient and organized storage of multiple hay stands.

The body 12 of the hay stand 10 is constructed by pouring the structural foam material into a form 20 that is constructed to yield the desired shape. The structural foam has two chemicals that are mixed and then poured into the form 20. The foam then heats and rises to take on the shape of the interior of the form 20. Once the foam is fully cured, the form is removed, and the hay stand is ready for use. In some embodiments, a small piece of PVC (not shown) is inserted into the form 20, causing the structural foam to mold around the PVC. This provides a reinforced hole which can be used to stack multiple hay stands on a stacking rack.

To use the device, a user simply transports the hay stand 10 to the location where hay is to be located and places the hay stand 10 on the ground. Round or square bales can then be placed on top of the hay stand 10. When the hay is removed from the hay stand 10, it can be easily picked up by the user and stored, transported or repositioned.

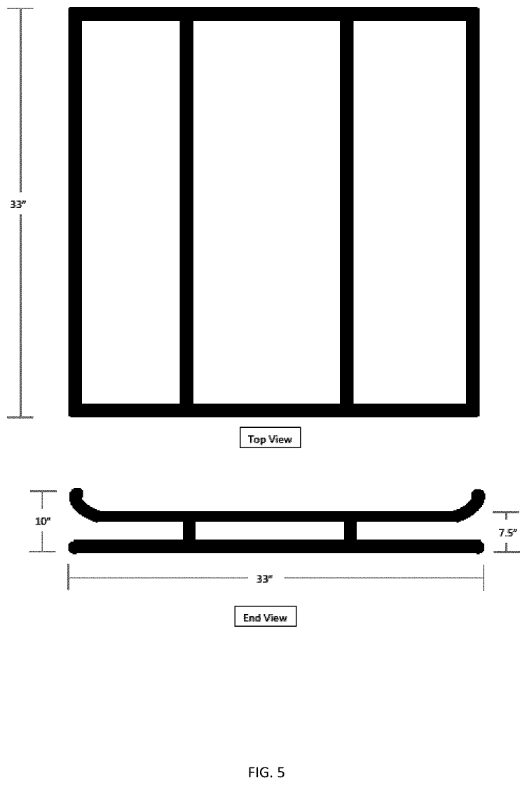

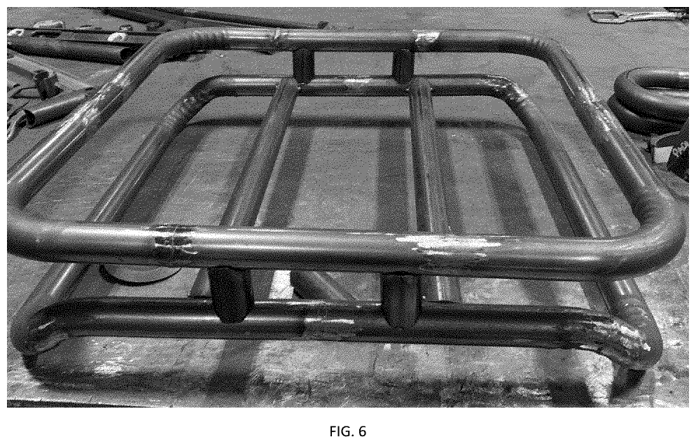

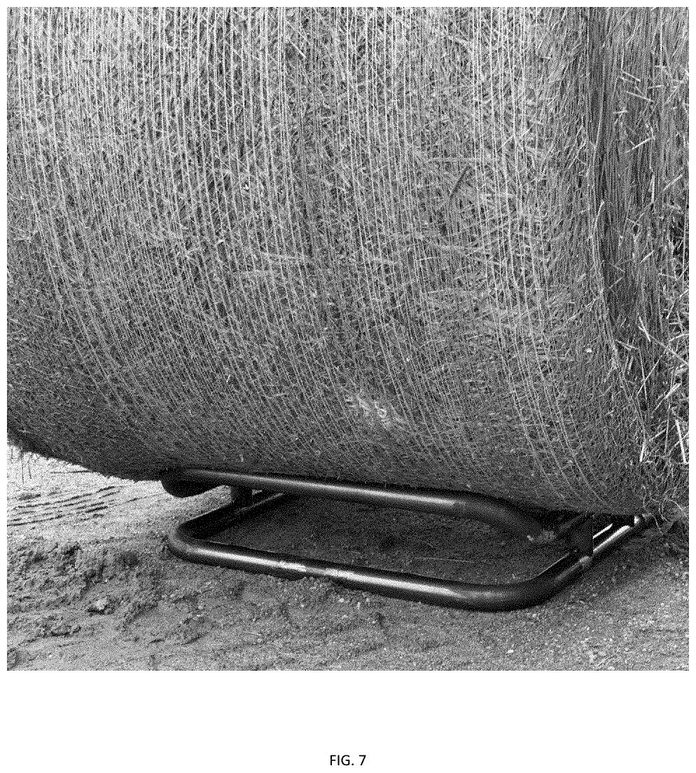

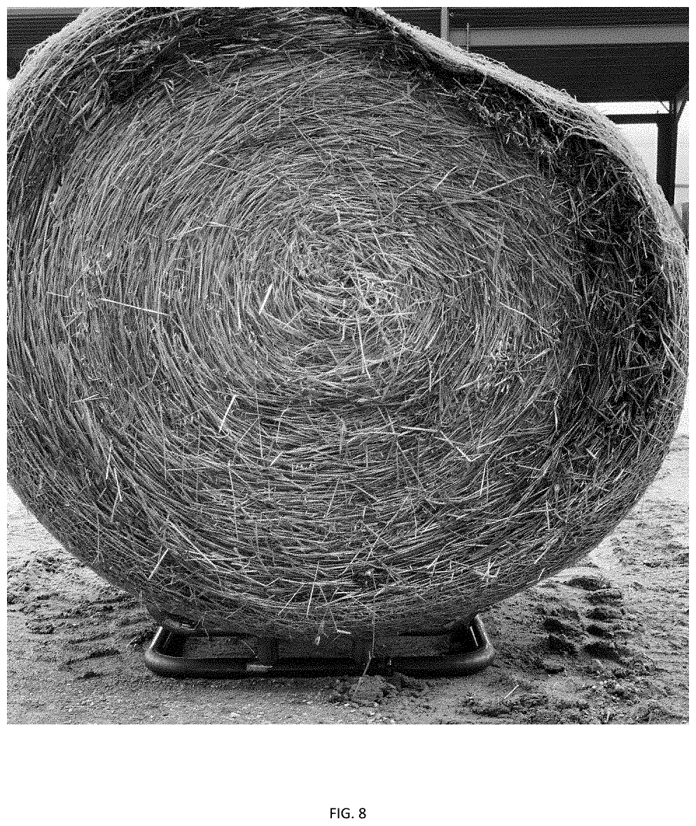

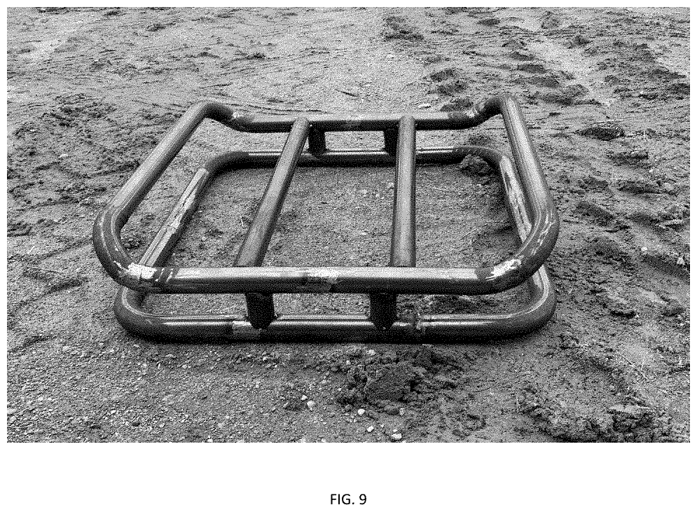

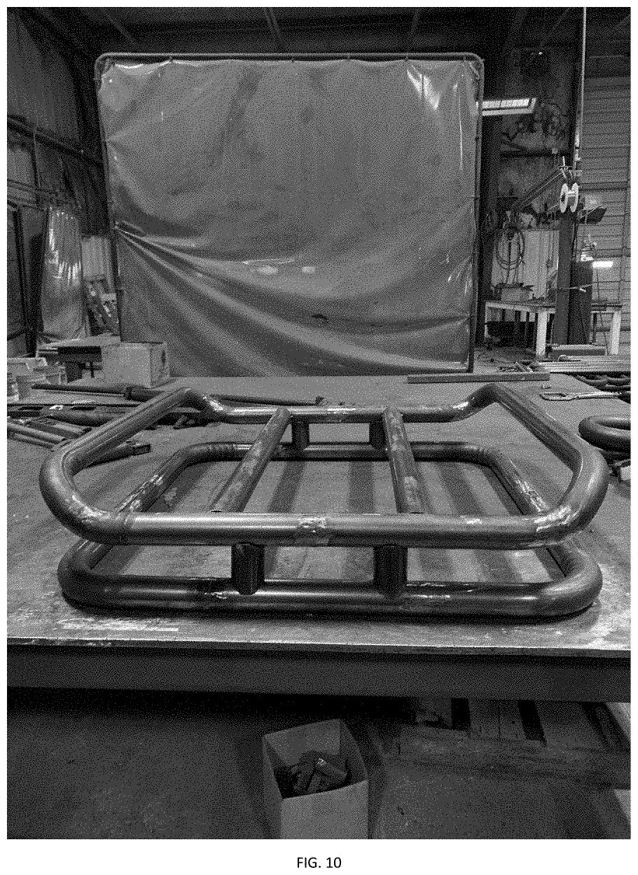

An alternative embodiment of the hay stand 10 is shown in FIGS. 5-10. These devices can be made from metal or any other suitably strong material. The details of construction will be apparent to those skilled in the art from the drawings. In use, the device can be used for round bales when the curved side is facing upwards or can be used for square bales when the curved side is facing downward.

1. A hay stand for supporting hay above the ground comprising:
a solid body portion; and
wherein the solid body portion is formed of polyurethane structural foam.

2. The hay stand of claim 1 wherein the body is formed in the shape of a rectangular prism or cuboid.

3. A method for forming a hay stand comprising:
mixing chemical ingredients for structural foam;
providing a form designed to yield the shape of a rectangular prism or cuboid;
pouring the mixture into a form;
waiting for the foam mixture to expand to take the shape of the form and to cure; and
removing the foam from the form.
